(19) United States
(12) Patent Application Publication
(10) Pub. No.: US 2005/0217346 A1
(43) Pub. Date: Oct. 6, 2005

(54) Flow measurement calibration

(76) Inventors: Siddharth P. Nagarkatti, Acton, MA (US); William Randolph Clark, Hampstead, NH (US); Ali Shajii, Canton, MA (US)

Correspondence Address: Mark G. Lappin;McDERMOTT, WILL & EMERY, 28 State Street, Boston, MA, 02109, US

(21) Appl. No.: 10/819,639

(22) Filed: Apr. 6, 2004

(51) Int. Cl. G01P 21/00

(52) U.S. Cl. 73/1.16

(57) ABSTRACT

A flow measurement calibration system and method is presented that actively regulates the pressure of the fluid being tested. A piston is slidably mounted to an inner wall of a chamber, which has a fluid inlet port for receiving an inflow of fluid into the interior of the chamber. The piston moves through the length of the chamber in response to fluid pressure exerted by the fluid flowing into the chamber. A piston actuator imparts motion to the piston, in response to command signals from a controller. The controller is responsive to the output of a pressure sensor, which senses the fluid pressure, and a position/velocity sensor, which senses the position and velocity of the piston. The controller commands the piston actuator to dynamically adjust the position and velocity of the piston so that the fluid pressure remains substantially constant at a desired setpoint.

### BACKGROUND

Thermal mass flow sensors determine the mass flow rate of a fluid, by measuring the heat transfer to a fluid flowing in a tube, and generating an electrical output signal as a function of fluid flow rate. An exemplary thermal mass flow sensor may include a capillary sensor tube with a plurality of resistive elements (for example coils) disposed in thermal contact with the tube at different locations along the tube. The sensor tube can be heated by applying an electric current to the resistive elements. As fluid flows through the sensor tube, a temperature differential ΔT may be created between the resistive elements, as a result of the heat transfer of the flowing fluid. Because the fluid heat transfer, or equivalently the temperature differential ΔT, is proportional to the mass flow rate and the heat capacity of the fluid, an electrical output signal can be generated that is proportional to the flow rate.

These thermal mass flow sensors may often be coupled to a mass flow controller, which may include: (1) a thermal mass flow sensor, as described above, and (2) a bypass flow channel, which contains a laminar flow device, and through which the bulk of the gas flows. Typically, the inlet and outlet of the components (1) and (2) tend to coincide. The flow split ratio between the mass flow sensor and the bypass channel can be viewed as remaining constant, through the flow range of the instrument. The total flow through the instrument can be inferred by measuring the flow through the sensor tube and then adding the amount flowing through the bypass, the latter amount being determined by measuring the flow split ratio between the two components (1) and (2).

In order to maintain the accuracy and consistency of these flow measurement results, the mass flow controllers should be calibrated. A number of calibration methods are known in the art, including the constant pressure method, the constant volume method, and the gravimetric method, by way of example. A known calibration system that is based on the constant pressure method is the piston prover-type flow calibration system. This calibration system is generally used as a primary flow standard. A conventional piston prover-type flow measurement system may typically include a counterweight-pulley-piston assembly, which affects passive pressure regulation.

The conventional counterweight-pulley-piston assembly, based on passive pressure regulation, may have a number of disadvantages, however. For example, the counterweight-pulley system can introduce cyclic errors such as eccentricity and mechanical run-out. Also, hazardous materials such as mercury may have to be used as a sealing mechanism. Further, stick-and-slip type of piston motion may occur, which in turn may result in pressure perturbations that can introduce errors in the flow measurement.

### SUMMARY

A flow measurement calibration system is presented that implements an active pressure regulation mechanism. A cylinder-piston assembly includes a controller configured to actively regulate the fluid pressure within the cylindrical chamber that encloses the volume of fluid. In particular, the controller regulates the motion of the piston so as to maintain the fluid pressure within the cylinder substantially constant at a predetermined setpoint. The change in the enclosed fluid volume, at a constant fluid pressure and at constant fluid temperature, is used to compute the fluid inlet flow.

In one embodiment, the calibration system includes a cylindrical chamber having at least one fluid inlet port for receiving an inflow of fluid. A piston is slidably mounted to the walls of the cylindrical chamber. The piston is adapted to move through the length of the chamber as fluid flows into the chamber through the inlet port, effecting a barrier to incoming fluid. A controller dynamically adjusts the position of the piston so as to maintain the pressure of the fluid constant at a user-defined setpoint.

The calibration system includes a piston actuator for moving the piston so as to induce fluid displacement within the chamber by a desired amount. The calibration system further includes a pressure sensor for sensing the pressure of the fluid within the chamber, and a position/velocity sensor for sensing the position and velocity of the piston. The calibration system includes a controller that is responsive to the output of the pressure sensor and the position/velocity sensor, and that controls the motion of the piston by sending command signals to the piston actuator. The calibration system may optionally include a temperature sensor for sensing the temperature of the fluid within the chamber, so that the temperature of the fluid may also be maintained constant within the chamber.

The controller is configured to receive the output signals from the pressure sensor and the position/velocity sensor. In response to any changes in fluid pressure, the controller dynamically adjusts the position and velocity of the piston by sending command signals to the piston actuator, until the pressure of the fluid enclosed within the chamber remains substantially at the desired setpoint. Typically, the setpoint is about 1 atm. Given constant pressure and temperature, the change in the enclosed volume of fluid is used to compute the inlet flow rate of the fluid.

### BRIEF DESCRIPTION OF THE DRAWINGS

FIG. 1 illustrates a schematic view of a constant pressure-based flow measurement system, known in the art, which is configured as a counterweight-pulley-piston assembly, and which operates based on passive pressure regulation.

FIG. 2 illustrates a partially schematic and partially block diagrammatic view of an active constant pressure-based flow measurement system in accordance with one embodiment, which includes a linear motor disposed in a horizontal orientation.

FIG. 3 illustrates a schematic view of an active constant pressure-based flow measurement system in accordance with another embodiment, in which a linear motor having a vertical orientation is used.

FIG. 4 illustrates an isometric view of an active constant pressure-based flow measurement system in accordance with another embodiment, which includes a linear motor having a horizontal orientation, and including a cylindrical piston rod that imparts motion to the piston head, in a syringe-like configuration.

### DETAILED DESCRIPTION

A system and method is presented for calibrating mass flow measurement systems. As known, calibration of a measuring instrument is the process of characterizing the measuring instrument by determining the deviation of the instrument from a known standard, to ascertain any correction factors for the instrument. The calibration process ensures an accurate and repeatable performance of the instrument. In particular, a flow measurement calibration system and method is presented that is not based on passive pressure regulation in a cylinder-piston assembly, but rather implements active control of the motion of the piston in the cylinder-piston assembly.

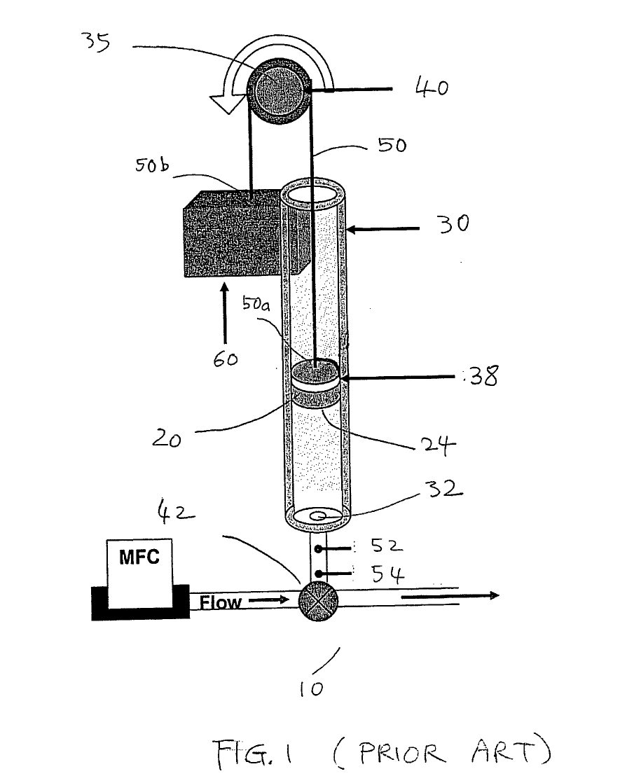

FIG. 1 illustrates a constant pressure-based flow measurement calibration system 10, which is known in the art. The flow measurement calibration system 10 is a piston prover-type calibration system that is configured as a counterweight-pulley-piston assembly. The calibration system 10 operates by passive pressure regulation. In particular, the operating principle is based on the relationship between the inlet fluid flow, and the change in volume under constant pressure and temperature.

The conventional calibration system 10 includes a piston 20 that is mounted within a hollow chamber 30, and a counterweight-pulley system 35. The piston 20 slides as fluid is introduced into, or removed from, the chamber 30 through an inlet port 32. A gas-tight liquid seal 38 is provided between the outer lateral surface of the piston 20 and the inner surface of the annular wall of the cylindrical chamber 30, in order to prevent the enclosed fluid from escaping the enclosure. Mercury, which is a hazardous material, is often used as the liquid seal 38 to achieve lower friction. The piston may include an annular groove for receiving liquid mercury. The sliding liquid mercury seal 38 allows the piston 20 to experience minimal frictional forces when moving up or down within the chamber 30, while at the same time providing a gas-tight seal between the piston 20 and the chamber 30.

The conventional calibration system 10 typically includes an elongated cable 50 or other connecting structure, usually formed of a material that can flex without undergoing noticeable stretching. The cable 50 has one end 50a secured to the piston 20, and an opposite end 50b secured to a counterweight 60. The cable 50 imparts rotational motion to the pulley, when the piston 20 moves due to the introduction of fluid into the chamber 30 or the exiting of fluid from the cylindrical chamber 30. The counterweight 60 acts to reduce the weight of the piston 20, and thereby reduce the compression by the piston 20 of the fluid accumulating within the chamber 30.

The conventional calibration system 10 typically also includes a precision encoder 40 that generates a signal representative of the change in a predetermined unit of the volume of the enclosed fluid. For example, the encoder 40 may be a shaft angle encoder including a rotatable shaft onto which the pulley is secured, and which extends from one end of the encoder 40. The shaft angle encoder 40 senses each incremental change in shaft angle position of the pulley. The change in shaft angle position represents the linear movement of the piston 20, which in turn represents the change in volume of the fluid enclosed within the interior of the chamber 30.

When a flow measurement cycle starts, fluid flows into the chamber 30 through the inlet port 32, and the pressure on the bottom end of the piston 20 starts to exceed the pressure at the upper end of the piston 20. As a result, the pressure differential across the piston 20, in conjunction with the counterweight 60, generates a force that pushes the piston 20 up to maintain a zero pressure differential across the piston 20. The static friction and mass of the piston 20 and the counterweight 60 are removed from the computation during the initial flow application. During this time the piston 20 is accelerated and the piston movement is not measured, and any slowness of the piston 20 in becoming mobilized is not considered. The piston movement is only measured when the piston is moving at a constant velocity, and the pressure is constant. Typically the pressure is slightly above atmospheric pressure (enough to overcome the friction of the mercury seal and the pulley system).

Because the counterweight-pulley-piston assembly has no active actuation, the friction must be kept constant in order to achieve repeatable and accurate piston motion. As mentioned earlier, however, the piston position-dependent variation of frictional force inside the tube can cause stick-and-slip type of irregular piston motion, i.e. wobble, which in turn results in pressure perturbations. These pressure perturbations introduce errors in the flow measurement, because the operating principle requires that the pressure of the fluid being tested be constant at all times. Furthermore, any pressure perturbation will cause temperature transients, which may further degrade the flow measurement accuracies. If a tighter sealing mechanism is used, the increased Coulomb (static) and viscous (dynamic) friction may worsen the stick-and-slip motion, resulting in increased flow measurement errors. Any fluctuations in the atmospheric pressure during a measurement cycle may also translate into inaccuracies in flow measurements. Finally, the pulley system introduces cyclic errors such as eccentricity and mechanical run-out.

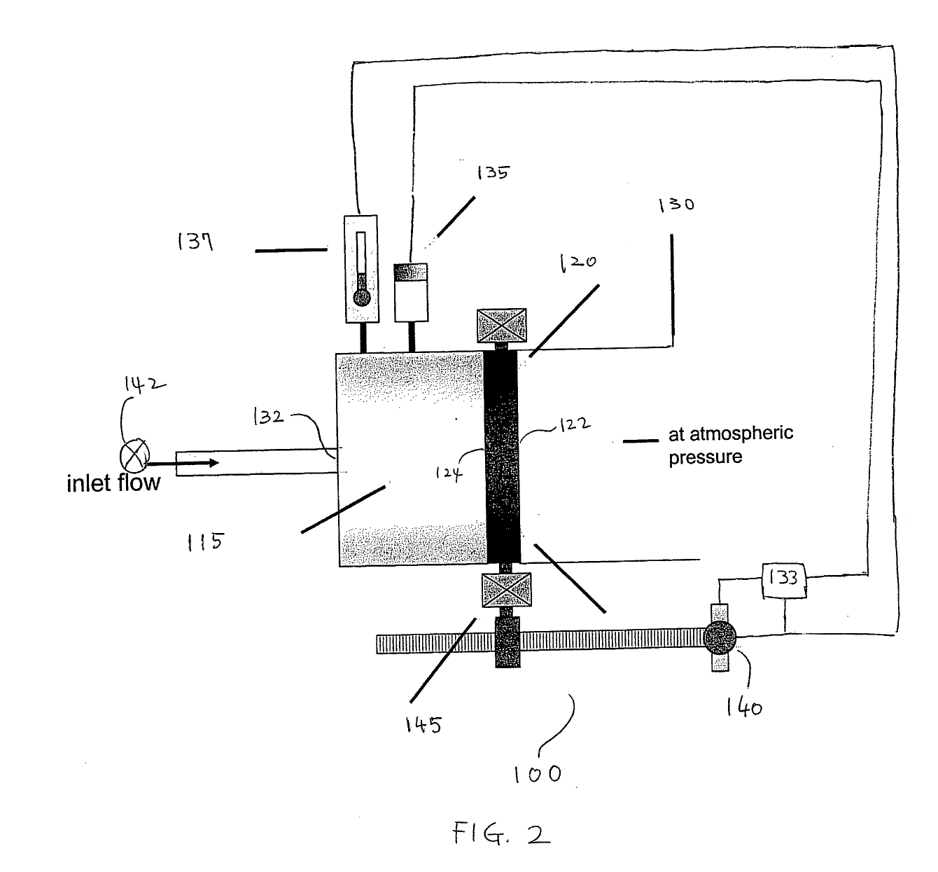

FIG. 2 illustrates a constant pressure-based flow measurement calibration system 100 based on active pressure regulation, constructed in accordance with one embodiment of the present invention. The active calibration system 100 includes a hollow chamber 130, and a piston 120 that is slidably mounted to the inner walls of the chamber 130. In the active flow measurement calibration system 100, the passive counterweight-pulley-piston assembly is replaced by an active control system that dynamically regulates the fluid pressure within the chamber by controlling the movement of the piston in response to the output of a pressure sensor and a position/velocity sensor.

In the illustrated embodiment, the chamber 130, as well as the piston 120, has a substantially cylindrical shape, the outer diameter of the piston 120 being just slightly less than the inner diameter of the chamber 130. The piston 120 and the chamber 130 have substantially uniform cross-sections. The cylindrical chamber 130 includes an inlet port 132 configured to receive an inflow of fluid 115 into the interior of the chamber 130. The fluid 115 is the test fluid whose mass flow measurement is being calibrated. The test fluid 115 may be a gas or a liquid.

The cylindrical piston 120 is slidably moved by the fluid 115 that is introduced into, or removed from, the chamber 130. A valve 142 regulates the flow of the fluid 115 into and out of the chamber 130. The piston 120 is configured to move through the length of the chamber 130, in response to fluid pressure exerted by the fluid 115 flowing into the chamber 130 through the inlet port 132. The cylindrical piston 120 includes an upper end 122 and a lower end 124. The outer surface of the upper end 122 of the piston 120 is exposed to atmospheric pressure. When the fluid 115 is introduced into the chamber 130 through the inlet port 132, the introduced fluid 115 becomes enclosed between the outer surface of the lower end 124 of the piston 120, and the inlet port 132. The volume of the enclosed fluid 115 changes as a function of the linear movement of the piston 120.

The calibration system 100 includes an actuator 140, a position/velocity sensor 133, and a pressure sensor 135. The calibration system 100 further includes a controller (not shown) that controls and coordinates the operation of the actuator 140, the position-velocity sensor 133, and the pressure sensor 135, in such a way that the pressure of the test fluid 115 remains substantially constant throughout the motion of the piston 120. The controller may be located within the actuator 140, as in the embodiment illustrated in FIG. 2; alternatively, the controller may be an external controller that is connected to the actuator 140 and the sensors 133 and 135.

The pressure sensor 135 is configured to sense the fluid pressure within the chamber 130. Any pressure transducer known in the art may be used. The position/velocity sensor 133 is configured to sense the position and velocity of the piston. The actuator 140 is configured to impart motion to the piston 120 so as to induce a fluid displacement within the chamber 130, in accordance with one or more command signals from the controller. In the illustrated embodiment, the actuator 140 is a linear motor. In other embodiments, however, other types of actuators may be used, for example a rotary motor. In one embodiment, the controller that is located within (or is connected to) the actuator 140 may also control and coordinate the operation of a temperature sensor 137, in such a way that the temperature of the test fluid 115 also remains constant throughout the motion of the piston 120. Any temperature transducer known in the art may be used.

The actuator 140 imparts motion to the piston 120, in response to command signals from the controller, thereby inducing a fluid displacement within the chamber 130. The controller is configured to receive the output of the pressure sensor 135 and the position/velocity sensor 133, and to determine the difference between the measured value of the fluid pressure and a desired setpoint for the fluid pressure. The pressure setpoint is typically user-defined; however in some forms of the invention the pressure setpoint may be defined by entities other than the user, or may be built into the calibration system. A typical pressure setpoint is about 1 atm.

If the difference between the measured pressure and the setpoint is greater than a tolerance value, the controller commands the actuator 140 to dynamically adjust the position and velocity of the piston 120, until the fluid pressure as sensed by the pressure sensor 135 returns to a value that differs from the setpoint by an amount less than or equal to the tolerance value. The tolerance value is quite small, i.e. the actuator 140 continues to adjust the position and velocity of the piston 120 until the pressure of the enclosed fluid becomes substantially equal to the desired setpoint. In this way, the pressure of the enclosed fluid is actively regulated to remain substantially constant at the desired setpoint, throughout any motion of the piston.

Optionally, the controller may be further configured to receive the output of the temperature sensor 137, and to determine the difference between the measured value of the fluid temperature and a desired setpoint for the fluid temperature. By analogy to the process described in the previous paragraph, if the difference between the measured temperature and the temperature setpoint is greater than a small tolerance value, the controller commands the actuator 140 to modify the position and velocity of the piston 120 (i.e. to move the piston) until the measured fluid temperature becomes substantially equal to the desired setpoint value.

Given a substantially constant pressure and temperature, the controller is configured to compute the flow rate of the fluid 115, by measuring the change in the volume of the fluid enclosed between the outer surface of the lower end 124 of the piston 120, and the inlet port 132. By comparing the measured flow rate with a known standard, the deviation of the mass flow controller device (that is being calibrated) from the known standard can be determined, and any requisite correction factors can be ascertained. The calibration system 100 can be used as a primary flow standard, ensuring the measurement repeatability and accuracy of the mass flow controller.

The controller may include a computer-readable medium having stored therein computer-readable instructions for a processor. These instructions, when read and implemented by the processor, cause the processor to input and store the output from the pressure sensor 135 and the position/velocity sensor 133, and to implement the steps described in the previous paragraph, namely: 1) determine the difference between the measured value of the fluid pressure and a setpoint value for the fluid pressure; 2) if the difference is greater than a tolerance value, command the actuator 140 to adjust the position and velocity of the piston; 3) input and store the new output values from the pressure sensor 135 and the position/velocity sensor 133; and 4) repeat steps 1, 2, and 3 until the difference between the measured value of the fluid pressure and the setpoint value becomes less than or equal to the tolerance value. Additional instructions may cause the same process to be performed with respect to a temperature sensor. The computer-readable medium may contain further instructions that cause the processor to input and store values representative of a change in the volume of the enclosed fluid, the change resulting from the regulated motion of the piston, and to compute the fluid inlet flow rate, using the change in volume. The computer-readable medium may be any medium known in the art, including but not limited to hard disks, floppy diskettes, CD-ROMs, flash memory, and optical storage devices. The computer-readable instructions described above may be provided through software that is distributed through the Internet.

The position/velocity sensor 133 may be, but is not limited to, an optical encoder, a resolver, a laser, or an ultrasound sensor. In the illustrated embodiment, the position/velocity sensor 133 is a linear optical encoder. As known in the art, optical encoders convert a mechanical position into a representative electrical signal, and include linear encoders, which sense linear motion, and angular encoders, which sense rotational motion. In the illustrated embodiment, the optical encoder is a linear encoder which senses the linear displacement and velocity of the piston 120, and generates output signals representative of the real-time position and velocity of the piston 120. In other embodiments, however, for example in embodiments in which the actuator 140 is a rotary actuator, the optical encoder may be an angular encoder which senses the angular displacement and velocity of the piston 120 and generates output signals representative thereof.

The components of an optical encoder typically includes a patterned strip (for linear encoders) or a patterned disk (for angular encoders), a light source, one or more photodetectors, and an interface electronics unit which allows position and speed information to be derived from the output of the photodetectors. In a linear optical encoder, the strip has digital code marks on it, in the form of an alternation of transparent and opaque areas on the strip. The linear position of the strip (or the angular position of the disk, in the case of an angular encoder) is defined as a train of digital pulses. Binary symbols (“0” and “1”) are provided by the alternation of transparent and opaque areas that are sensed by the light source—photodetector system.

In other embodiments, a resolver may be used as a position/velocity sensor 133. As known in the art, a resolver (often called a “synchro resolver”) is a form of a “synchro,” which is a generic term for a family of transducing instruments, each of which can be connected together in various ways to form shaft angle measurement and positioning systems. Typically, synchros include a rotor within one or more windings capable of revolving inside a fixed stator. When the rotor winding of a synchro is excited by an AC voltage, the voltage induced in any stator winding becomes proportional to the angle between the rotor coil axis and the stator coil axis. The synchro shaft angle is related in a known way to the voltages that appear across the stator terminals, and thus can be obtained by measuring these voltages. A resolver is a form of a synchro in which the windings on the stator and rotor are displaced mechanically at 90 degrees to each other. The resolver thus exploits the sinusoidal relationship between the shaft angle and the output voltage. In other embodiments, a laser rangefinder or an ultrasound sensor may be used as the position/velocity sensor 133.

A coupling 145 is provided between the actuator 140 and the piston 120. The coupling 145 may be a substantially rigid coupling. In the illustrated embodiment, the coupling 145 between the actuator 140 and the piston 120 is a magnetic bearing. Other embodiments of the invention may use other types of coupling, for example a rack-pinion type coupling, a ball-screw type of coupling, or a coupling having a syringe-like configuration.

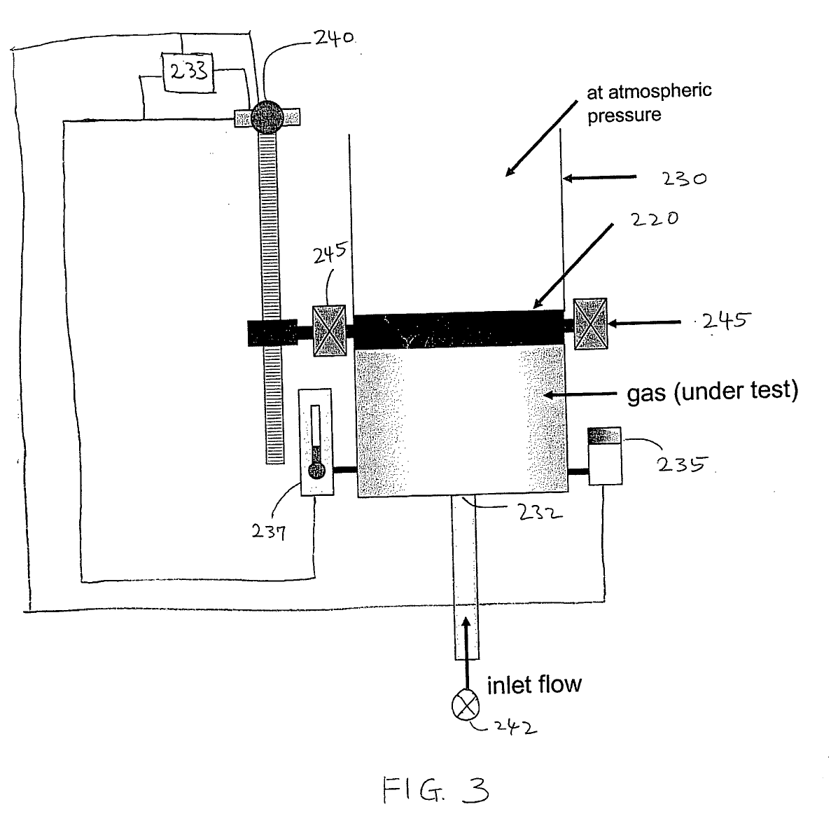

FIG. 3 illustrates an active constant pressure-based flow measurement system 200, which is constructed in accordance with another embodiment of the present invention, and which uses a linear motor in a vertical orientation. By analogy to the calibration system 100 illustrated in FIG. 2, the calibration system 200 includes a hollow chamber 230, a piston 220 slidably mounted to the inner walls of the chamber 230, an inlet port 232 for introducing test fluid into the chamber 230, and a controller (located within an actuator or connected to the actuator) that actively regulates and coordinates the operation of an actuator 240, a position/velocity sensor 233, a pressure sensor 235, and a temperature sensor 237. A magnetic bearing coupling is provided between the piston 220 and the actuator 240. In the illustrated embodiment, the actuator 240 is a linear motor. The components and the operation of the system 200 is similar to the components and the operation of the system 100, except for the added contribution of gravity to the motion of the piston 220. The controller is responsive to the output of the sensors 233 and 235, and commands the actuator 240 to adjust the position and velocity of the piston 220 in such a way that the fluid pressure and temperature (as sensed by the sensors 233 and 235) remains substantially constant at a desired setpoint, throughout the motion of the piston 220.

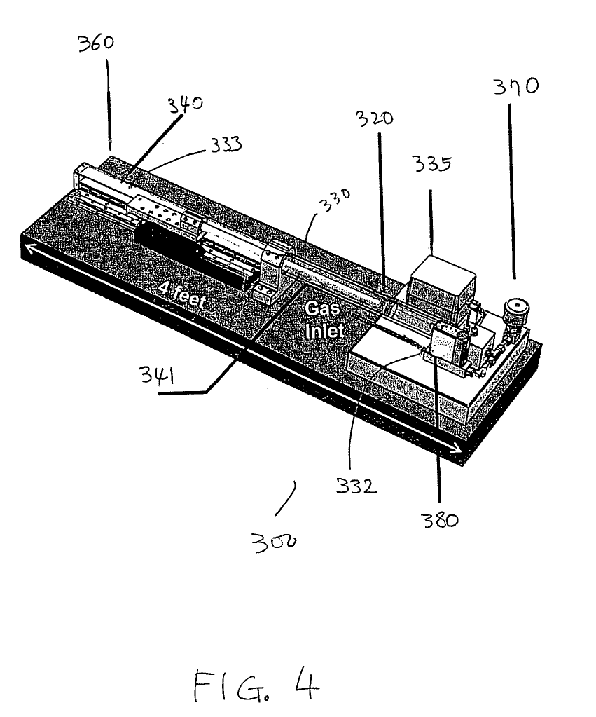

FIG. 4 illustrates an active constant pressure-based flow measurement calibration system 300, constructed in accordance with another embodiment. In the embodiment illustrated in FIG. 4, a linear motor 340 is provided that is disposed in a horizontal orientation, and that has a syringe-like configuration. In particular, a cylindrical piston rod 341 is provided in order for the motor 340 to impart motion to a piston 320, which is slidably mounted within a substantially cylindrical chamber 330. In the illustrated embodiment, the piston rod 341 is made of borosilicate; however, other embodiments may include piston rods that are made from materials other than borosilicate. The piston 320 includes a piston head that is sealed within the chamber 330. A controller (located within the motor 340 in the illustrated embodiment) actively regulates and coordinates the operation of the motor 340, a linear encoder 333, and a pressure sensor 335, by analogy to the embodiments described in FIGS. 2 and 3 above. The illustrated calibration system 300 has a length of about 4 feet, and is optionally fabricated upon a vibration isolation mounting plate 360.

In the illustrated embodiment, the pressure sensor 335 is a Baratron, which is a trademarked name of a capacitance monometer made by MKS Instruments, Inc. of Andover, Mass., the present assignee. In other embodiments, other types of pressure transducers may be used. The Baratron 335 is adapted to gauge pressure, by measuring the position of a diaphragm. This measurement is a measure of the change in capacitance between two electrodes. As the shape of the diaphragm changes, due to the pressure (that is being measured), the capacitance changes, resulting in a signal representative of the pressure.

In the illustrated embodiment, an inlet 332 for inflow of gas is shown adjacent to a unit 380 that is being tested. In the illustrated embodiment, the unit 380 is a mass flow controller having a thermal mass flow sensor and a bypass flow channel, although in other embodiments, the unit 380 may be other types of instruments that is being calibrated. A bypass valve 370 is provided in the calibration system 300, in order to regulate the inflow of fluid into the chamber 330.

The calibration systems 100 (FIG. 2), 200 (FIG. 3), and 300 (FIG. 4) all operate under analogous principles. In operation, when a flow measurement cycle begins, the fluid-under-test pressure starts to increase over the setpoint (which may be user-defined). This increase in pressure is measured by the pressure sensor (represented as 135, 235, and 335 in FIGS. 2, 3, and 4, respectively) and fed back to the controller. Based on this pressure measurement, the controller implements a model-based control scheme, and commands the actuator, in real-time, to move the piston to a position such that the pressure of the fluid being tested is regulated to the user-defined setpoint. The model-based control system may optionally also incorporate temperature information available via temperature measurements by a temperature sensor. Given constant pressure and temperature, the change in the volume of the enclosed fluid is then used by the controller to compute the inlet flow of the fluid being tested, as explained earlier.

The calibration system and method described in this section provides a number of advantages, compared to the counterweight-piston-pulley system known in the art that is based on passive pressure regulation. One advantage is that active pressure control reduces pressure perturbations from all sources, thereby improving the accuracy of the flow measurements. In conjunction with a calibrated pressure transducer, the actuator in the calibration system described above allows flow measurements to be independent of atmospheric pressure fluctuations. Another advantage is that cyclic errors associated with counterweight-pulley systems can be eliminated.

A further advantage is that the hazardous mercury seal can be replaced with a tighter seal comprised of non-hazardous, non-reactive materials. This is because active position control, as implemented in the system described above, can apply a controlled translational force that is orders of magnitude higher than any frictional force. As a result, the low friction sealing constraint is eliminated, allowing the replacement of the mercury seal with seals comprised of non-hazardous, non-reactive materials. Yet another advantage is that the higher velocity capability of the actuator (compared to the piston velocity capability of the counterweight-piston-pulley system) can extend the flow measurement range of the device being calibrated, for a given chamber size. Finally, another advantage of the calibration system described above is that the calibration system can work in both a horizontal and a vertical orientation, or for that matter any orientation, whereas the counterweight in the conventional piston-pulley system mandates that the pulley-based system be vertically oriented.

While the calibration system and method have been described and shown with reference to specific embodiments, it should be understood by those skilled in the art that various change in form and detail may be made therein. Many other embodiments are possible.

Other embodiments are within the following claims.

1. A flow measurement calibration system, the system comprising:
a chamber having at least one fluid inlet port configured to receive an inflow of fluid into the interior of said chamber;
a piston slidably mounted to an inner wall of said chamber and configured to move through the length of said chamber in response to fluid pressure exerted by the fluid flowing into said chamber through said inlet port; and
a controller adapted to dynamically adjust the motion of said piston so as to maintain the fluid pressure substantially constant at a setpoint.

2. A system in accordance with claim 1, further comprising:
a piston actuator configured to impart a motion to said piston so as to induce a fluid displacement within the chamber;
a pressure sensor configured to sense the fluid pressure within said chamber;
a position and velocity sensor configured to sense the position and velocity of said piston; and
wherein said controller is responsive to the output of said pressure sensor and said position and velocity sensor, and
wherein said controller is configured to command said piston actuator to adjust the position and velocity of said piston until the fluid pressure, sensed by said pressure sensor, is substantially at the set-point.

3. A system in accordance with claim 2, further comprising a temperature sensor for sensing the temperature of the fluid within said chamber.

4. A system in accordance with claim 3, wherein said controller is further responsive to the output of said temperature sensor, and wherein said controller is further configured to command said piston actuator to maintain the position and velocity of said piston at values for which the temperature of the fluid, as sensed by said temperature sensor, is substantially constant.

5. A calibration system in accordance with claim 1, wherein said chamber has a substantially cylindrical configuration.

6. A calibration system in accordance with claim 5, wherein said piston also has a substantially cylindrical configuration, and wherein the outer diameter of said piston is slightly less than the inner diameter of said chamber.

7. A calibration system in accordance with claim 1, wherein said chamber and said piston have a substantially uniform cross-section.

8. A calibration system in accordance with claim 2, wherein said piston actuator comprises at least one of a rotary motor and a linear motor.

9. A calibration system in accordance with claim 2, wherein said piston actuator comprises a linear motor disposed in a substantially horizontal configuration, and wherein said chamber is also disposed in a substantially horizontal configuration.

10. A calibration system in accordance with claim 2, wherein said piston actuator comprises a linear motor disposed in a substantially vertical configuration, and wherein said cylindrical chamber is also disposed in a substantially vertical configuration.

11. A calibration system in accordance with claim 2, wherein said position/velocity sensor comprises at least one of: an optical encoder; a resolver; a laser sensor; and an ultrasound sensor.

12. A calibration system in accordance with claim 2, wherein said pressure sensor comprises a capacitance manometer.

13. A calibration system in accordance with claim 1, further comprising a valve for regulating the flow of the fluid through said inlet port.

14. A calibration system in accordance with claim 1, further comprising a coupler configured to couple said piston to said actuator.

15. A calibration system in accordance with claim 14, wherein said coupler is configured to provide a substantially rigid coupling between said piston and said actuator.

16. A calibration system in accordance with claim 15, wherein said coupler comprises at least one of: a magnetic bearing; a rack-pinion; a ball-screw; and a cylindrical piston rod coupled to a head of said piston in a syringe-like configuration.

17. A calibration system in accordance with claim 1, wherein the setpoint comprises a user-defined setpoint.

18. A calibration system in accordance with claim 1, wherein the setpoint is about 1 atm.

19. A calibration system in accordance with claim 1, wherein said chamber includes an upper end and a lower end, and wherein the outer surface of said upper end is exposed to atmospheric pressure.

20. A calibration system in accordance with claim 2, wherein said controller is further configured to compute a flow rate of said fluid by measuring the change in the volume of the fluid enclosed within said chamber at a substantially constant fluid pressure.

21. A method of calibrating flow measurements, the method comprising:
slidably mounting a piston to the inner walls of a chamber having at least one inlet port for introducing fluid therewithin, so that said piston is movable through the length of said chamber as fluid flows into said chamber through said inlet port; and
dynamically adjusting the position of said piston so as to maintain the pressure of said fluid substantially constant at a setpoint.

22. A method in accordance with claim 21, wherein the step of dynamically adjusting the position of said piston comprises:
moving the piston so as to induce fluid displacement within the chamber;
measuring the position and velocity of the piston;
measuring the pressure of the fluid within the chamber, and determining the difference between the measured value of the fluid pressure and the user-defined setpoint;
if the difference is greater than a tolerance value, adjusting the position and velocity of the piston; and
repeating the steps of measuring the position and velocity of the piston, and the fluid pressure, and determining the difference between the measured fluid pressure and the user-defined setpoint, until the difference is less than or equal to the tolerance value.

23. A method in accordance with claim 21, further comprising the step of computing the flow rate of the fluid that flows into said chamber through said inlet port by measuring the change in the volume of the fluid that is enclosed within said chamber at a fluid pressure that is substantially constant.

24. A computer-readable medium having stored therein computer-readable instructions for a processor, wherein the instructions, when read and implemented by the processor, cause the processor to:
a) input and store data representative of the position and velocity of a piston as measured in real-time, the piston being configured to move through the length of a chamber so as to induce a fluid displacement within the chamber, the chamber having at least one fluid inlet port for receiving an inflow of fluid into the interior of the chamber;
b) input and store data representative of the pressure of the fluid within the chamber as measured in real-time;
c) compute the difference between the measured value of the fluid pressure and a user-defined setpoint;
d) if the computed difference is greater than a tolerance value, adjust the position and velocity of the piston; and
e) repeat steps a, b, c, and d until the computed difference is less than or equal to the tolerance value.
